(19) United States
(12) Patent Application Publication
(10) Pub. No.: US 2025/0388102 A1
(43) Pub. Date: Dec. 25, 2025

(54) ELECTRIC DRIVE SYSTEM AND METHOD FOR CHARGING

(71) Applicant: MERCEDES-BENZ GROUP AG, Stuttgart (DE)

(72) Inventors: Urs BOEHME, Ehningen (DE); Stefan SEIFFERT, Filderstadt (DE); Julian KEMPF, Schoenaich (DE)

(21) Appl. No.: 19/244,315

(22) Filed: Jun. 20, 2025

(30) Foreign Application Priority Data
Jun. 22, 2024 (DE) 10 2024 002 035.7

(51) Int. Cl. B60L 53/24; B60L 15/00; B60L 50/60; B60L 53/10; B60L 53/16

(52) U.S. Cl. CPC B60L 53/24; B60L 15/007; B60L 50/60; B60L 53/11; B60L 53/16; B60L 2210/10; B60L 2210/42; B60L 2220/56

(57) ABSTRACT

An inverter for charging an electric drive system for a vehicle includes three half- bridges, each with two semiconductor switches, respectively coupled to center taps of one of the stator windings. A diode or semiconductor switch with diode function is arranged with reverse polarity between the center tap of one of the half bridges and a contact of the charging socket. A diode or semiconductor switch with diode function is arranged with reverse polarity between the center tap of another of the half-bridges and another contact of the charging socket. In each case a diode or semiconductor switch with diode function is arranged with forward polarity from a negative high-voltage potential of the inverter to each of the two contacts of the charging socket. An insulating DC/DC converter is switched between DC terminals of the inverter and DC terminals of the high-voltage battery and can be bridged two main contactors.

### CROSS-REFERENCE TO RELATED APPLICATIONS

This application claims priority under 35 U.S.C. § 119 to German patent application 10 2024 002 035.7, filed on Jun. 22, 2024, the entire content of which is herein expressly incorporated by reference.

### BACKGROUND AND SUMMARY OF THE INVENTION

Exemplary embodiments of the invention relate to an electric drive system for a vehicle, as well as to a method for charging a high voltage battery of the electric drive system.

In charging stations according to the NACS system (North American Charging System), only two terminals are available via which either AC or DC is charged. With the opening of the Tesla@ Supercharger for non-commercial customers, a large DC-400 V charging network can be used, which, however, requires additional measures within the vehicle for 800 V vehicles in order to be able to carry out a DC charging process. Such measures could be:
internal boost converters: the disadvantage here is that additional large and expensive components, contactors are required for DC charging operation with and without boost converters (bypass),
Switchover batteries: the disadvantage here is that additional changeover contactors are required and that the useable installation space for battery cells is reduced. Furthermore, the auxiliary aggregates must be configured from the 800 V voltage range for operation in the 400 V voltage range (i.e., to approximately 200 V when the battery is empty).
Boost function using the inverter and the leakage inductance of the e-machine: The disadvantage here is that the star point on the e-machine must be designed to be accessible, that only the leakage inductance of the e-machine is effective, and that a bypass contactor is required for charging at 800 V (and higher current than at 400 V).
Boost function using the inverter with DC 400 V supply between a phase connection of the e-machine and the switching module output of the inverter: The disadvantage here is that the charging current is limited to the design of an inverter half-bridge and that a bypass contactor is required for charging at 800 V with a higher current.

Only single-phase charging is possible with the AC grid in the USA. The input voltage can be 120 Vrms or 240 Vrms. Up to 80 Arms is the usual target value for the current.

DE 10 2021 003 883 A1 describes an electric drive system for a vehicle, having a switching device that has
a first switching state, in which a charging connection is directly connected to an electrical energy storage device of the vehicle, such that the electrical energy storage device can be charged with an input voltage which is applied to the charging connection,
a second and third switching state, in which the charging connection is connected to the electrical energy storage device via an inverter, such that the electrical energy storage device can be charged depending on the inverter.

DE 10 2021 003 852 A1 describes an electric drive system for a vehicle, having
an electric three-phase engine for driving the vehicle
an electrical energy storage device for electrically supplying the electrical three-phase engine during driving operation of the vehicle,
an inverter of the electrical three-phase engine, which is electrically coupled to the electrical energy storage device, and
a charging connection on the vehicle for electrically coupling the electrical energy storage device to a charging unit external to the vehicle, wherein
a charging voltage of the charging connection on the vehicle can be converted into a supply voltage for charging the electrical energy storage device depending on the inverter.

Exemplary embodiments of the invention are directed to a novel electric drive system for a vehicle and a novel method for charging a high voltage battery of the electric drive system.

An electric drive system for a vehicle is disclosed, having an electric engine with three stator windings for driving the vehicle, a high-voltage battery, and an inverter for converting a direct voltage of the high-voltage battery into an alternating voltage for supplying the electric engine, wherein the inverter has a B6 bridge made of three half-bridges, which are each formed from two semiconductor switches, to the center taps of which one of the stator windings is connected in each case, wherein furthermore a charging socket for charging the high-voltage battery by means of a direct voltage and/or for single-phase charging of the high-voltage battery by means of an alternating voltage is arranged.

According to the invention, a diode or a semiconductor switch with a diode function is arranged between the center tap of one of the half bridges and a contact of the charging socket with the polarity reversed. Furthermore, a diode or a semiconductor switch with a diode function is arranged between the center tap of another of the half bridges and another contact of the charging socket with the polarity reversed. Furthermore, a diode or a semiconductor switch with a diode function is arranged with forward polarity from a negative high-voltage potential of the inverter to each of the two contacts of the charging socket. Furthermore, an insulating DC/DC converter is connected between the DC connections of the inverter and the DC connections of the high-voltage battery and can be bridged by means of two main contactors.

In an embodiment, at least one of the semiconductor switches of the half-bridge and/or at least one of the semiconductor switches with diode function is designed as a MOSFET or IGBT with free-wheeling diode.

In an embodiment, the inverter has a DC-link capacitor.

In an embodiment, the inverter has current measuring devices for AC current measurement between the center taps of the half-bridges and the stator windings.

In an embodiment, two relay contacts are arranged between the respective conductors and the diodes or semiconductor switches with diode function connected to them for voltage isolation of two conductors of the charging socket.

According to an aspect of the present invention, a method for charging the high-voltage battery of the electric drive system described above at a DC charging station with boost function is proposed, wherein the DC charging station is connected to the charging socket. According to the invention, a semiconductor switch arranged as a low-side switch of one of the half-bridges, which is connected to the charging socket via one of the diodes or semiconductor switches with diode function, is controlled in a clocked manner, wherein the insulating DC/DC converter for transmitting power from the DC link capacitor to the high-voltage battery is driven in a clocked manner or bypassed by means of the main contactors.

According to a further aspect of the present invention, a method for charging the high-voltage battery of the electric drive system described above at an AC charging station is disclosed, wherein the AC charging station is connected to the charging socket. According to the invention, during a positive half-wave of an AC voltage fed in by the AC charging station, a semiconductor switch arranged as a low-side switch of one of the half-bridges, which is connected to the charging socket via one of the diodes or semiconductor switches with diode function, is controlled in a clocked manner. During a negative half-wave of the AC voltage fed in by the AC charging station, a semiconductor switch arranged as a low-side switch of another of the half-bridges, which is connected to the charging socket via one of the diodes or semiconductor switches with a diode function, is controlled in a clocked manner. A power transfer is carried out from the DC link capacitor to the high-voltage battery via the insulating DC/DC converter.

According to a further aspect of the present invention, a method for charging the high-voltage battery of the electric drive system described above at a DC charging station without boost function is proposed, wherein the DC charging station is connected to the charging socket. According to the invention, a current for charging is conducted via the body diodes or freewheeling diodes of the semiconductor switches arranged as high-side switches, wherein the insulating DC/DC converter is operated in a clocked manner or bridged by means of the main contactors to transfer power from the DC link capacitor to the high-voltage battery.

In an embodiment, at least one of the semiconductor switches and semiconductor switches with diode function is closed as soon as a current flows through its body diode or freewheeling diode.

According to a further aspect of the present invention, a method is proposed for emergency operation of the electric drive system described above, wherein the insulating DC/DC converter is operated in a clocked manner in the event of a problem in the control system and/or in the event of an insulation fault in the high-voltage battery or in a subsystem on the side of the main contactors facing towards the high-voltage battery or in the event of a blown main fuse for transferring power from the high-voltage battery to the inverter.

In an embodiment, a target current is regulated by clocking the semiconductor switches.

According to the present invention, the inverter is extended in each case by two semiconductors with diode function for two half bridges in each case. In doing so, a single-phase PFC function can be realized using the inverter and the motor inductance. In addition, an insulating DC/DC converter is used to provide galvanic insulation during AC charging or (if necessary) during DC charging. The boost function can also be realized by the inverter and the motor inductance.

The PFC function for AC charging is provided by the inverter and the e-machine with little additional effort (two diodes, two semiconductor switches). Thus, the PFC of the on-board charger can be omitted. The main inductance of the e-machine acts as a PFC choke. The e-machine does not rotate during the charging process. Furthermore, the bulk capacitor of a typical on-board charger (OBC) can be omitted, since the DC link capacitor is used for this purpose. The e-machine and the inverter are used as a boost DC/DC converter from 400 V to 800 V, such that an alternative charging solution such as a boost converter or switchover battery etc. can be omitted. Emergency charging is possible via the inverter and the insulating DC/DC converter (e.g., when a limit of the C1 characteristic curve could be exceeded). An emergency drive function exists if the battery main contactors open due to a fault (e.g., an insulation fault when the vehicle is started). During DC charging at 400 V and the occurrence of an insulation fault in the vehicle (varistor tripping in EVSE due to insulation overload), a battery short circuit is avoided. The connections outside the critical commutation cell between the MOSFET and DC link capacitor have no influence on the inverter switching function (efficiency/voltage utilization). The solution according to the invention enables the realization of a NACS charging system for DC 800 V, DC 400 V and AC (single-phase) without additional switching elements in the charging path.

Exemplary embodiments of the invention are explained in more detail below by means of the drawings.

### BRIEF DESCRIPTION OF THE DRAWING FIGURES

Here are shown in:

FIG. 1 a schematic view of an inverter for operating an electric engine with a wiring, including a charging socket,

FIG. 2 a schematic view of the inverter when. charging with boost function on a DC charging station,

FIG. 3 a schematic view of the inverter when charging without boost function on a DC charging station,

FIG. 4 a schematic view of the inverter when carrying out an emergency charging function with boost function on the DC charging station,

FIG. 5 a schematic view of the inverter when carrying out an emergency charging function without boost function on the DC charging station,

FIG. 6 a schematic view of the inverter when carrying out an AC charging function on an AC charging station during a positive voltage half-wave,

FIG. 7 a schematic view of the inverter when carrying out an AC charging function on an AC charging station during a negative voltage half-wave,

FIG. 8 a schematic view of the inverter when carrying out an emergency driving function with reduced power,

FIG. 9 a schematic diagram with signals of a simulation of the inverter when charging on a DC charging station with boost function,

FIG. 10 a schematic diagram with signals of the simulation of the inverter if an insulation error occurs,

FIG. 11 a schematic diagram with further signals of the simulation of the inverter for illustrating a potential distribution,

FIG. 12 a schematic diagram with signals of a simulation of the inverter when charging on the AC charging station,

FIG. 13, in a schematic diagram with signals of the simulation of the inverter when AC charging at the start of the positive half-wave, and

FIG. 14 a schematic diagram with signals of the simulation of the inverter wen AC charging at the start of the negative half-wave.

Parts corresponding to one another are provided with the same reference numerals in all Figures.

### DETAILED DESCRIPTION

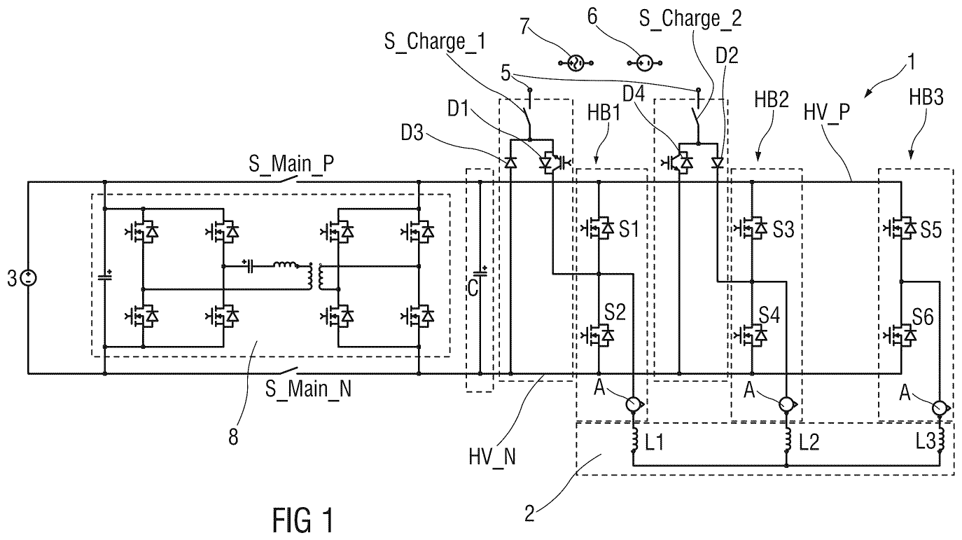

FIG. 1 is a schematic view of an inverter 1 for operating an electric engine 2, for example a drive engine of an electrically driven vehicle, in particular a passenger car, a utility vehicle, or a bus. The inverter 1 has a B6 bridge made of three half bridges HB1, HB2, HB3 switched between a positive high-voltage potential HV_P and a negative high-voltage potential HV_N, which are each formed by two semiconductor switches S1 to S6, in particular MOSFETs or IGBTs with a freewheeling diode. Furthermore, the inverter 1 has an intermediate circuit capacitor C and current measuring devices A, in particular for alternating current measurement, at the center taps of the half bridges HB1 to HB3. The electric engine 2 has three stator windings L1 to L3, which are connected to the center taps of the half-bridges HB1 to HB3.

The inverter 1 is configured by corresponding wiring to be used when charging a high-voltage battery 3 of the vehicle by means of direct voltage or by means of a single-phase alternating voltage via a charging socket 5, in particular a NACS charging socket.

Two charging relays S_Charge_1, S_Charge_2 are provided for voltage isolation of charging socket 5.

Furthermore, a diode D1 is arranged as a coupling element D1 for the center tap of a first half-bridge HB1 of the inverter 1, polarized in the reverse direction to a first connection of the first charging relay (e.g., S_Charge_1). As an alternative to diode D1, another semiconductor component D1 can also be used as shown in FIG. 1, for example a MOSFET with a body diode in the direction of the diode D1 shown, an IGBT with a corresponding freewheeling diode, etc.

Furthermore, a diode D2 is arranged as coupling element D2 for the center tap of a second half-bridge HB2 of the inverter 1, polarized in the reverse direction to a second connection of the second charging relay (e.g. S_Charge_2). As an alternative to diode D2, another semiconductor component D2 can also be used, for example a MOSFET with a body diode in the direction of the diode D2 shown, an IGBT with a corresponding freewheeling diode, etc.

Furthermore, a diode D3 is connected as coupling element D3 in the forward direction from the negative high-voltage potential HV_N to the first charging relay S_Charge_1 and a diode D4 is connected as coupling element D4 in the forward direction from the negative high-voltage potential HV_N to the second charging relay S_Charge_2. As an alternative to the diodes D3, D4, another semiconductor component D3, D4 can also be used, for example a MOSFET with body diode in the direction of the diode D3, D4 drawn, an IGBT with corresponding freewheeling diode, etc.

In order to enable a potential-free AC charging function, an insulating DC/DC converter 8 is switched between the DC connections of the inverter 1, i.e., between the positive high-voltage potential HV_P and the negative high-voltage potential HV_N, and the DC connections of the HV battery 3 (FIG. 1 shows an example of an insulating DC/DC converter 8 in LLC topology. Alternatively, other insulating DC/DC converter topologies are possible, for example dual-active bridge, phase shift full bridge, etc.).

The insulating DC/DC converter 8 can be connected directly to the DC connections or HV potentials of the HV battery 3 or have separate connection elements (not shown).

If a bidirectional charging function (V2x) or an emergency driving function is required, the insulating DC/DC converter 8 must be bidirectional. Only the charging mode is shown for the charging functions. The bidirectional charging function (V2x) is usually fed in with the current flowing in the opposite direction and is not depicted.

The DC connections of the HV battery 3 are connected via main contactors S_Main_P, S_Main_N to the positive high-voltage potential HV_P and the negative high-voltage potential HV_N and thus also to the DC connections of the inverter 1. Further components of the HV system not depicted may be: LV-DC/DC converter, heater, refrigerant compressor, etc.

In particular, the coupling elements D1 to D4 can be chosen in such a way that the DC charging current (boost function or 800 V charging) flows via components that are optimized in terms of their conduction losses and current carrying capacity, such as IGBTs, while cost-effective diodes that are designed for AC currents can be selected for the AC function. In general, either a diode D1 to D4 or a semiconductor switch D1 to D4 with a blocking effect for one current direction can be chosen for both components.

For charging a high-voltage battery 3 of a battery electric vehicle at a DC charging station 6, which provides a maximum output voltage (for example 500 V) that is lower than a nominal voltage (for example 800 V) of the high-voltage battery 3, various solutions are known in the prior art, for example a switchover battery, a separate boost DC/DC converter, boosting via the inverter 1 with or without disconnecting the neutral point, etc.

The present invention proposes a solution in which, during DC charging, a DC charging station 6 is connected to the inverter 1 and the electric engine 2 via the charging socket 5, the charging relays S_Charge_1 and S_Charge_2 and at least one of the coupling elements D1 to D4 (in particular coupling elements D1, D4 designed as IGBTs) in such a way that the function of a galvanically coupled DC/DC converter 8 can only be represented by means of a special control of the semiconductor switches S1 to S6. Since the current flow through the stator windings L1 to L3 represents a realistic operating point of the electric engine 2, the complete stator inductance can be used here. However, the electric engine 2 does not move.

In the event of an insulation fault in the vehicle, an overload of the insulation in the opposite HV_N potential of the DC charging station 6 can occur as a direct consequence. Protective varistors in the DC charging station 6 here cause a short circuit in the high-voltage battery 3. The problem of the battery short circuit (several thousand amperes) is avoided in the proposed architecture by the coupling element D4. When using a semiconductor switch D4 as coupling element D4, the short circuit can be recognized quickly, and the semiconductor switch D4 can be opened. Early detection can be determined via the displacement of the HV potentials in relation to the protective conductor PE and/or potential equalization PA, such that the semiconductor switch D4 can be opened before the varistor in the DC charging station 6 triggers and thus also before a short-circuit current is present in the structure. Moreover, here it is important that the respectively clocked semiconductor switch S1 to S6 in the inverter 1 is no longer activated (switched on) in the event of this double insulation fault. However, a short circuit in the DC charging station 6 may remain.

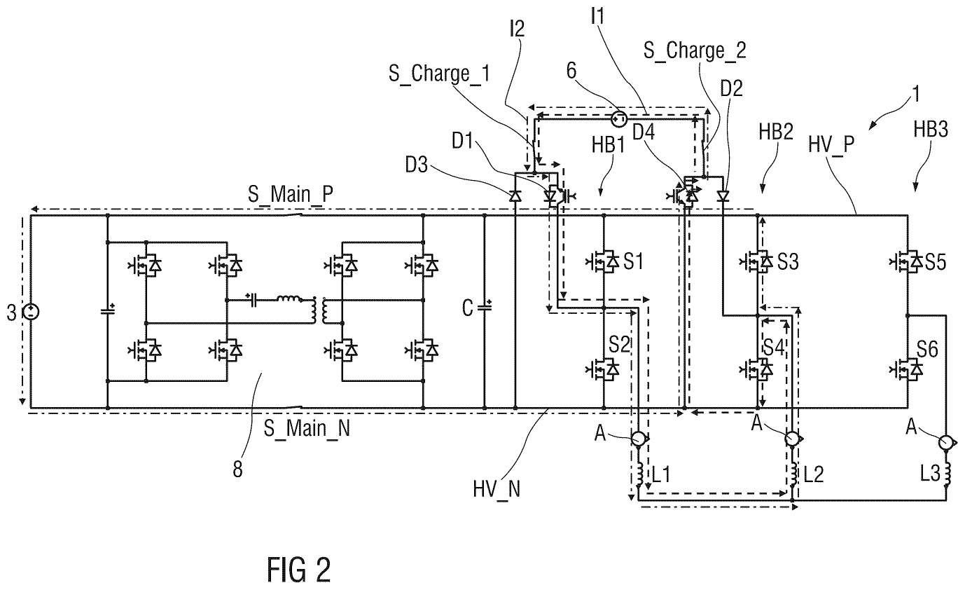

FIG. 2 is a schematic view of the inverter 1 when charging at the DC charging station 6 with boost function. It can be seen that only two of the four semiconductor switches D1 to D4, namely the semiconductor switches D1 and D4, are required for the boost function. They can also be replaced by MOSFETs or IGBTs for optimization at higher currents.

For DC charging by means of boost operation, the charging relays S_Charge_1, S_Charge_2 and the main contactors S_Main_P, S_Main_N are closed. Here, the semiconductor switch S4, i.e., the low-side switch S4 of one of the half- bridges HB1 to HB3, in particular the half-bridge HB2, is controlled in a clocked manner. When the semiconductor switch S4 is closed, a current I1 flows from the DC charging station 6 via the charging relay S_Charge_1, the coupling element D1, the stator winding L1, the star point of the electric engine 2, the stator winding L2, the semiconductor switch S4, the coupling element D4, and the charging relay S_Charge_2 back to the DC charging station 6. When the semiconductor switch S4 is open, a current 12 flows from the DC charging station 6 via the charging relay S_Charge_1, the coupling element D1, the stator winding L1, the star point of the electric engine 2, the stator winding L2, the body diode of the semiconductor switch S3, the high-voltage battery 3, the coupling element D4, and the charging relay S_Charge_2 back to the DC charging station 6.

As soon as the controlled semiconductor switch S4 is closed, the two stator windings L1 and L2 are supplied with the voltage of the DC charging station 6. The current 11 through the two stator windings L1 and L2 increases. The high-voltage battery 3 is not charged during this phase. If the controlled semiconductor switch S4 is opened, the only possible freewheeling path for the current 12 impressed in the stator windings L1 and L2 is via the body diode of the high-side switch located in the same half-bridge, in this case the semiconductor switch S3. To optimize losses, this semiconductor switch S3 can be closed as soon as the current I2 flows. The resulting current path leads via the high-voltage battery 3 such that it is charged.

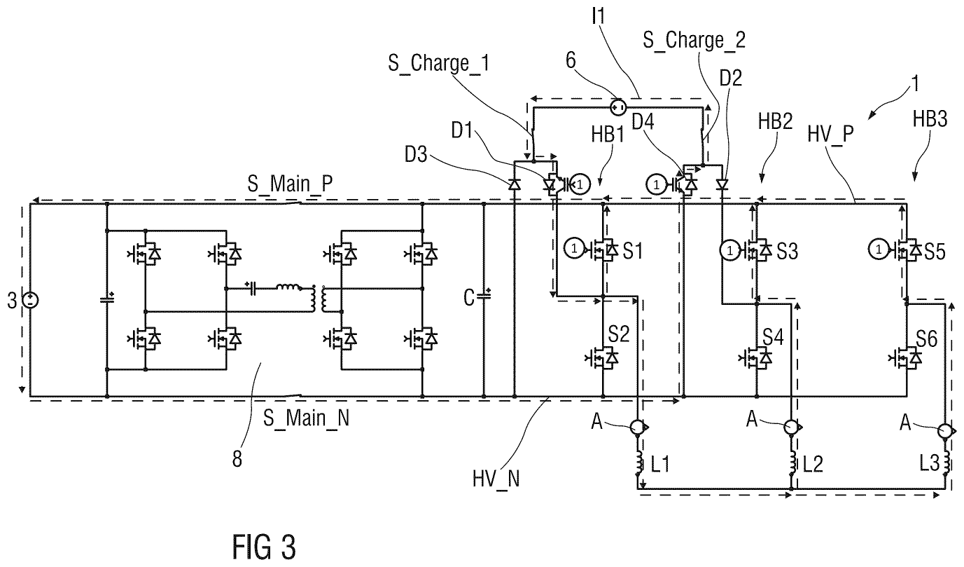

FIG. 3 is a schematic view of the inverter 1 when charging without boost function on the DC charging station 6 with 800 V, for example.

In order to charge the vehicle at an 800 V charging station (output voltage c. 920 V-950 V, for example), it is not necessary to operate inverter 1 in clocked manner. However, the entire DC charging current is still conducted via the inverter 1. Alternatively, an additional pair of contactors can be provided for charging at an 800 V station between the charging connections and the battery connections. In order to minimize the losses in the inverter 1 and to divide the charging current (approximately) into three paths, the three high-side switches S1, S3, S5 of the half bridges HB1 to HB3 are switched through for this purpose. In addition, the coupling elements D1, D4, which are formed as IGBTs, are switched through near the charging relays S_Charge_1, S_Charge_2. A current I1 thus flows from the DC charging station 6 via the charging relay S_Charge_1, the coupling element D1 and three parallel current paths through the inverter 1, the high-voltage battery 3, the coupling element D4 and the charging relay S_Charge_2 back to the DC charging station 6. Of the three parallel current paths, one runs via the high-side switch S1 of the first half-bridge HB1, a second via the stator windings L1 and L2 and the high-side switch S3 of the second half-bridge HB2 and a third via the stator windings L1 and L3 and the high-side switch S5 of the third half-bridge HB3. The maximum charging current to be commanded by the high-voltage battery 3 must be matched to the maximum current of the charging path depicted. Should a semiconductor switch S1, S3, S5 of the inverter 1 or the electric engine 2 reach a critical temperature value, the maximum current to be commanded by means of the DC charging station 6 can be commanded to a lower value.

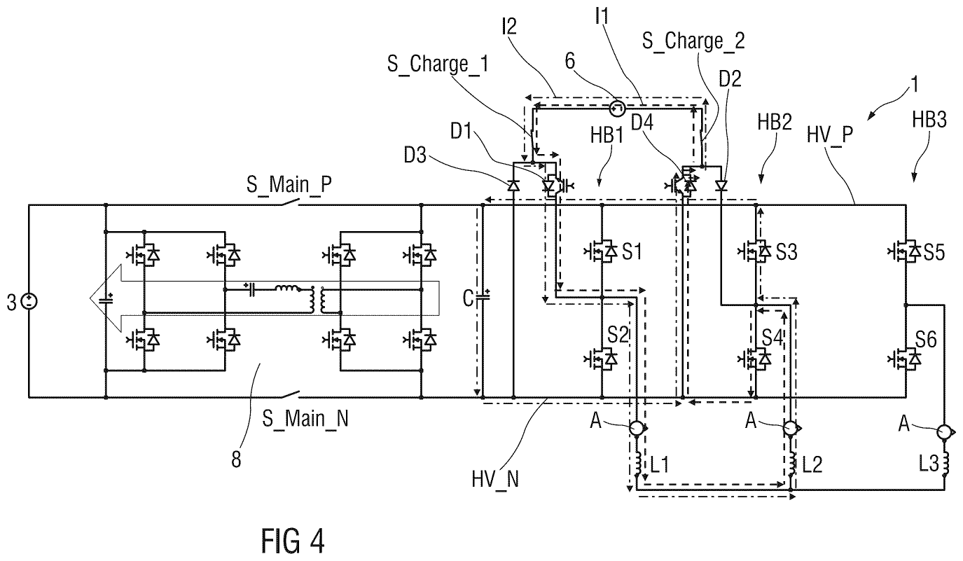

FIG. 4 is a schematic view of the inverter 1 when carrying out an emergency charging function with boost function at the DC charging station 6 with, for example, 400 V, wherein insulated charging is carried out.

When a galvanic connection of the entire vehicle to a DC charging station 6 is not desired or permitted, it is still possible to charge the vehicle with reduced power. By opening the main contactors S_Main_P, S_Main_N, the high-voltage battery 3 is electrically insulated from the DC charging station 6. When charging at a 400 V charging column, the inverter 1 with the coupling elements D1 to D4 functions as in the boost function described above, for example with the clock-operated low-side switch S4. In doing so, the DC link capacitor C or intermediate circuit capacitor C is charged. At the same time, the insulating DC/DC converter 8 is operated in clocked manner and transfers power from the DC link capacitor C from its side connected to the DC link capacitor C to its side connected to the high-voltage battery 3, wherein the two sides are galvanically insulated from each other by the main contactors S_Main_P, S_Main_N. Here, the transferable power is limited by the insulating DC/DC converter 8.

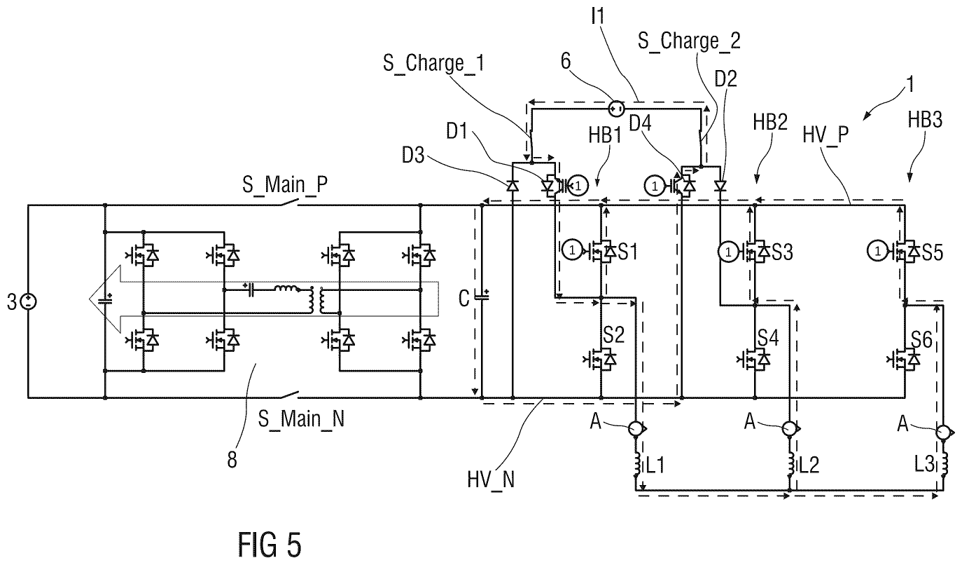

FIG. 5 is a schematic view of the inverter 1 when carrying out an emergency charging function without boost function at the DC charging station 6 with, for example, 800 V, wherein insulated charging takes place.

When a galvanic connection of the entire vehicle to a DC charging station 6 is not desired or permitted, it is still possible to charge the vehicle with reduced power. By opening the main contactors S_Main_P, S_Main_N, the high-voltage battery 3 is galvanically separated from the DC charging station 6. The inverter 1 now assumes the state as when DC charging at an 800 V charging station without boost function. Due to the lower transmission power, it is also possible to switch through only one or two of the high-side switches S1, S3, S5 instead of the three high-side switches S1, S3, S5. The DC link capacitor C is now charged by the charging station 6. At the same time, the insulating DC/DC converter 8 is in clocked operation and transfers power from the DC link capacitor C from its side connected to the DC link capacitor C to its side connected to the high-voltage battery 3. Here, the transferable power is limited by the insulating DC/DC converter 8.

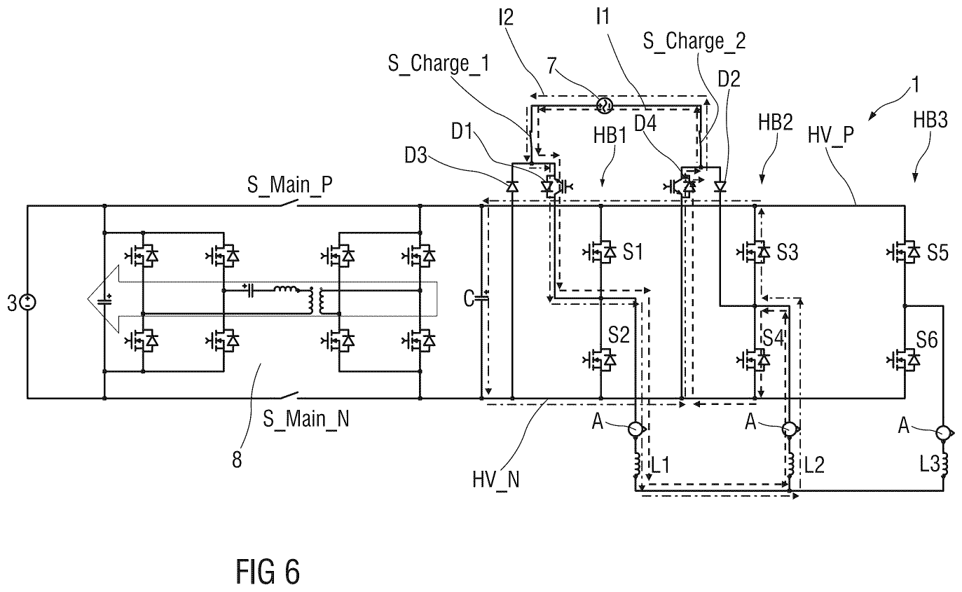

FIG. 6 is a schematic view of the inverter 1 when carrying out an AC charging function at an AC charging station 7 during a positive voltage half-wave.

The AC charging function for the positive voltage half-wave, in which the potential at charging relay S_Charge_1 is higher than at charging relay S_Charge_2, is identical or similar to the function for boosting with regard to the current curves in the inverter 1 (PFC function). Galvanic separation is provided when AC charging. The main contactors S_Main_P and S_Main_N are thus open, and the power is transferred from the DC link capacitor C of the inverter 1 to the high-voltage battery 3 via the galvanically insulating DC/DC converter 8, which is switched on at intervals for this purpose. The DC link capacitor C of inverter 1 replaces the function of the bulk capacitor and reduces the current ripple on the side of the high-voltage battery 3.

In a first state, the low-side switch S4 is closed. As soon as the low-side switch S4 is closed, a current I1 builds up via the stator windings L1 and L2. The two stator windings L1 and L2 are thus supplied with the voltage of the AC charging station 7. Here, the current I1 increases through the stator windings L1 and L2. The high-voltage battery 3 is not charged during this phase.

In a second state, the low-side switch S4 is open. Here, a freewheeling current I2 flows from the stator windings L1 and L2 via the body diode of the high-side switch S3 to the DC link capacitor C, from which the power is transferred to the high-voltage battery 3 via the galvanically insulating DC/DC converter 8, which is clocked in operation for this purpose. When the low-side switch S4 is opened, the only possible freewheeling path for the current I1 impressed in the stator windings L1 and L2 runs via the body diode of the high-side switch S3. To optimize losses, this high-side switch S3 can be closed as soon as the current flow starts. The resulting current path leads via the DC link capacitor C, from which the power is transferred to the high-voltage battery 3 via the galvanically insulating DC/DC converter 8, such that the high-voltage battery 3 is now charged. The current path leads from the negative high-voltage potential HV_N via the coupling element D4 back to the AC charging station 7.

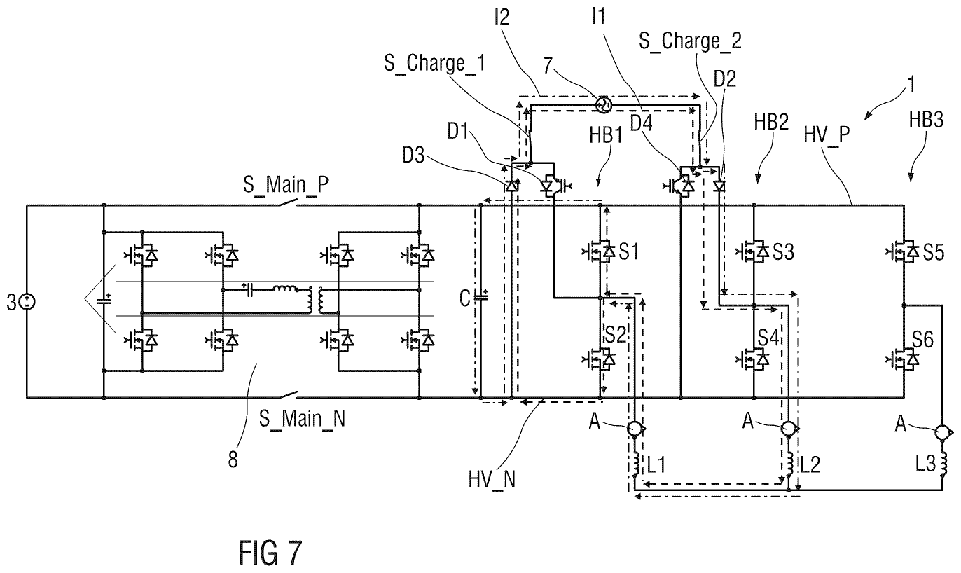

FIG. 7 is a schematic view of the inverter 1 when carrying out an AC charging function on an AC charging station 7 during a negative voltage half-wave.

In the AC charging function for the negative voltage half-wave, in which the potential at the charging relay S_Charge_1 is lower than at the charging relay S_Charge_2, the low-side switch S2 of another half-bridge HB1 of the inverter 1 is operated in a clocked manner in comparison to charging with the positive voltage half-wave. The current flow via the coupling elements D1 to D4 now also takes place via the semiconductors depicted as diodes D2, D3. The parallel coupling elements D1, D4, depicted as IGBTs, must be open. To ensure galvanic separation, the main contactors S_Main_P, S_Main_N are open as when charging with the positive half-wave, and power is transferred from the DC link capacitor C to the high-voltage battery 3 via the insulating DC/DC converter 8.

In a first state, the low-side switch S2 is closed. As soon as the low-side switch S2 is closed, a current I1 builds up via the stator windings L2 and L1. As soon as the low-side switch S2 is closed, the two stator windings L1 and L2 are supplied with the voltage of the AC charging station 7. The current 11 through the stator windings L1 and L2 increases. The high-voltage battery 3 is not charged during this phase.

In a second state, the low-side switch S2 is open. Here, a freewheeling current 12 flows from the stator windings L1 and L2 via the body diode of the high-side switch S1 to the DC link capacitor C, from which the power is transferred to the high-voltage battery 3 via the galvanically insulating DC/DC converter 8, which is switched on at intervals for this purpose. To optimize losses, this high-side switch S1 can be closed as soon as the current flow starts. The resulting current path leads via the DC link capacitor C, from which the power is transferred to the high-voltage battery 3 via the galvanically insulating DC/DC converter 8, such that the high-voltage battery 3 is now charged. The current path leads from the negative high-voltage potential HV_N via the coupling element D3 back to the AC charging station 7.

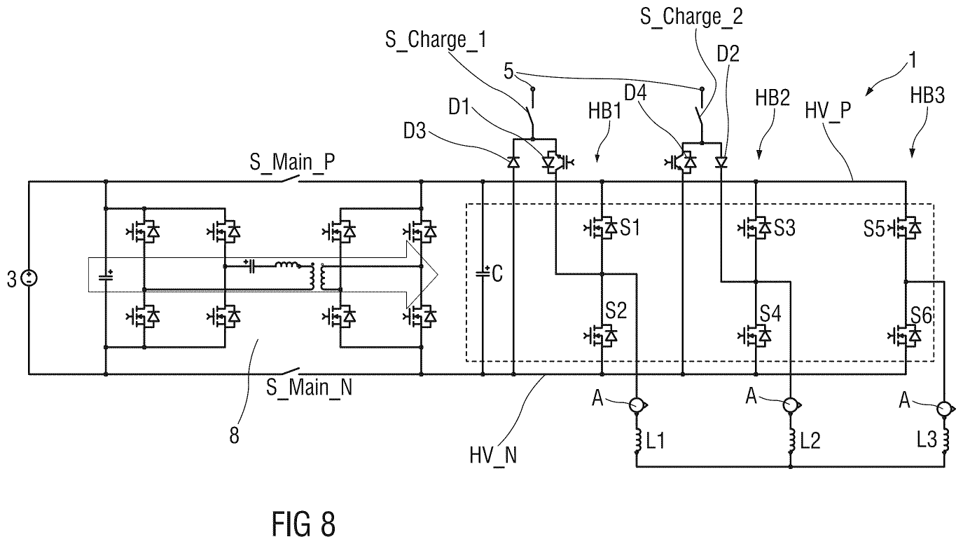

FIG. 8 is a schematic view of the inverter 1 when performing an emergency driving function with reduced power. If, for example, the main contactors S_Main_P, S_Main_N have opened or are held open due to a fault, emergency operation is possible via the insulating DC/DC converter 8. In this state, the charging relays S_Charge_1, S_Charge_2 are also open. The insulating DC/DC converter 8 transfers power from the high-voltage battery 3 to the inverter 1.

The trigger for such an opening of the main contactors S_Main_P, S_Main_N can be a problem in the control, an insulation fault in the high-voltage battery 3 or in the subsystem on the side of the main contactors S_Main_P, S_Main_N facing towards the high-voltage battery 3 or a blown main fuse (not depicted).

In the solution shown, the PFC function (Power Factor Correction) when AC charging is realized by the inverter 1 and the electric engine 2 with little additional effort (two diodes D2, D3, two semiconductor switches D1, D4). This eliminates the need for power factor correction (PFC) of an on-board charger. The main inductances of the stator windings L1 to L3 of the electric engine 2 are effective as PFC chokes. There is no rotation of the electric engine 2 during the charging process. Furthermore, the bulk capacitor of a typical on-board charger (OBC) can be omitted, since the DC link capacitor C is used for this purpose. The electric engine 2 and the inverter 1 are used as a boost DC/DC converter from 400 V to 800 V, such that an alternative charging solution such as a boost converter or switchover battery etc. can be omitted. Emergency charging is possible via the inverter 1 and the insulating DC/DC converter 8 (e.g. when a limit of the C1 characteristic curve could be exceeded). An emergency driving function exists when the main contactors S_Main_P, S_Main_N open due to a fault (e.g. an insulation fault when the vehicle is started). During DC charging at 400 V and the occurrence of an insulation fault in the vehicle (varistor tripping in DC charging station 6 due to insulation overload), a battery short circuit is avoided. The connections outside the critical commutation cell between the MOSFET and DC link capacitor C have no influence on the inverter switching function (efficiency/voltage utilization). The solution according to the invention enables the realization of a NACS charging system for DC 800 V, DC 400 V and AC (single-phase) without additional switching elements in the charging path.

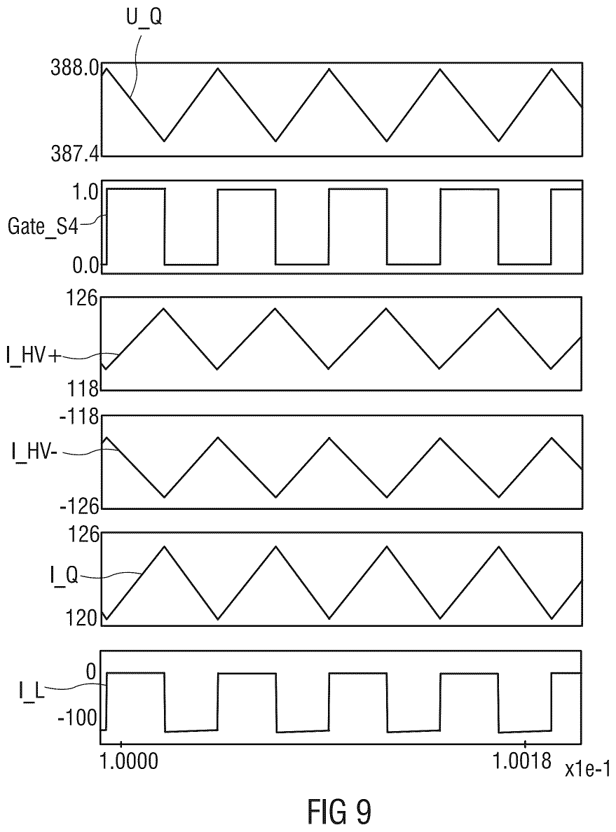

FIG. 9 is a schematic diagram with signals from a simulation of the inverter 1 (depicted in FIG. 1) with the wiring, wherein the boost function was depicted at 400 V at a DC charging station 6 (depicted in FIG. 1). A target current was specified within the limits of 120 A to 125 A. In the following two diagrams, the currents of the stator windings L1 to L3 (depicted in FIG. 1) and a control signal Gate_S4 for controlling the semiconductor switch S4 (depicted in FIG. 1) are shown. At a time t=0.5 s, an insulation fault occurs in the vehicle from the positive high-voltage potential HV+ to the potential equalization PA. At a time t=0.6 s, the cycle operation of the semiconductor switch S4 is stopped, and the semiconductor switch S4 remains open. At a time t=0.7 s, a second insulation fault occurs in the DC charging station 6 from the negative high-voltage potential HV_N (depicted in FIG. 1) to the potential equalization PA.

The following have been used as parameters for the simulation:
Insulation resistances: 1 MOhm
Inductivity of the stator windings L1 to L3: 1000 μF
Internal resistance Ri_Batt of the high-voltage battery 3 (depicted in FIG. 1) and the
DC charging station 6: 0.1 Ohm

In FIG. 9, a source voltage U_Q of the DC charging station 6, the control signal Gate_S4 for controlling the semiconductor switch S4, a current I_HV+ in the positive high-voltage potential HV+, a current I_HV− in the negative high-voltage potential HV−, a current I_Q from the DC charging station 6 and a charging current I_L flowing into the high-voltage battery 3 are depicted.

When the semiconductor switch S4 is closed, the current in the two stator windings L1 and L2 increases. It can be seen that the current I_Q of the DC charging station 6 is identical to the amount of current in the stator windings L1 and L2. During this time, the high-voltage battery 3 is not charged (charging current I_L=0). The current I_Q increases in this phase until it reaches the target value of 125 A. Normally, however, this would still be the case due to the large intermediate circuit capacitor C (depicted in FIG. 1) of the inverter 1. However, it has been omitted here in order to be able to better depict the function. As soon as the semiconductor switch S4 is opened upon reaching 125 A, the current I_Q of the DC charging station 6 flows both through the two stator windings L1 and L2 as well as through the high-voltage battery 3. Here, the current I_Q weakens. Once the value falls below 120 A, the semiconductor switch S4 is closed again.

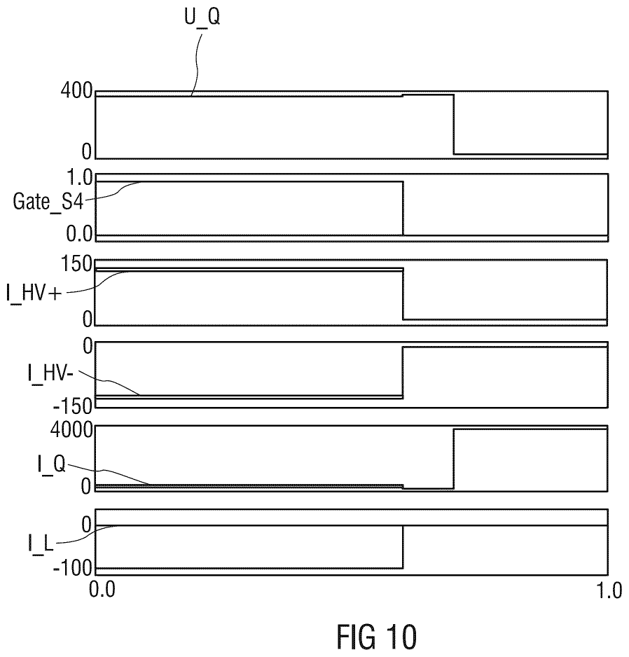

FIG. 10 is a schematic diagram with signals from the simulation of the inverter 1 (depicted in FIG. 1) with the wiring when insulation faults occur:

Over the entire time window of the simulation, an insulation fault initially occurs in the vehicle from the positive high-voltage potential HV+ to the potential equalization PA (insulation value is an ideal short circuit, i.e. 0 Ohm, time t=0.5 s). In this state, the circuit is still functioning correctly, i.e. the inverter 1 functioning as a booster can set the target current and thus uses it to charge the high-voltage battery 3 (depicted in FIG. 1). There are no short-circuit currents of the high-voltage battery 3 or the DC charging station 6 (depicted in FIG. 1). From the time t=0.6 s, the clocking of the semiconductor switch S4 (depicted in FIG. 1) is set. As soon as the clocking of the semiconductor switch S4 is set, the charging current I_L from the DC charging station 6 to the high-voltage battery 3 ends. There are still no short circuits.

From time t=0.7 s, the second insulation fault occurs from the negative high-voltage potential HV_N to the potential equalization PA in the DC charging station 6. There is no short-circuit current in the DC charging station 6, but a current that is, however, very high due to the rather low assumed value of 0.1 mOhm. In reality, this would mean that the DC charging station 6 is set to the maximum current of the command by the vehicle or the current corresponds to the maximum current of its power electronics (for example possible value with command by the vehicle 150 A or with maximum current of the DC charging station 6 500 A).

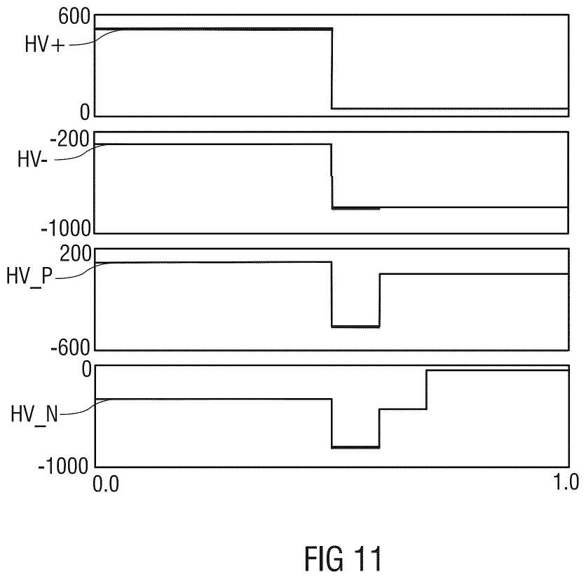

FIG. 11 is a schematic diagram with further signals of the simulation of the inverter 1 (depicted in FIG. 1) with the circuit to illustrate the potential distribution.

In the simulation, the high-voltage potentials HV_P, HV_N of the DC charging station 6 (depicted in FIG. 1) in the vehicle were recorded. This is particularly interesting when insulation faults are taken into consideration. In the time before t=0.5 s, the insulation is still intact. A uniform distribution of the insulation resistances is assumed (1 MOhm each). This leads to an almost symmetrical high-voltage distribution in the vehicle (500 V HV+ to PA and 300 V HV− to PA). The high-voltage distribution from HV− to PA of the vehicle is transferred to the side of the DC charging station 6, since the booster function is a galvanically coupled booster with a common negative high-voltage potential HV−, HV_N. The positive high-voltage potential HV_P at DC charging station 6 is reduced by the value of the booster, i.e. based on a voltage of 500 V from HV+ to PA in the vehicle and a voltage increase of 400 V by the booster, the voltage between HV_P and PA on the side of DC charging station 6 is 100 V.

From the time of the first insulation fault in the vehicle at t=0.5 s, the potentials in the vehicle and the DC charging station 6 shift downwards by 500 V. As soon as the cycling of the semiconductor switch S4 (depicted in FIG. 1) is stopped, the voltage difference between the high-voltage battery 3 (depicted in FIG. 1) (800 V) and the DC charging station 6 (400 V) at the diode D4 (depicted in FIG. 1) drops. Since the positive high-voltage potential HV_P is identical to the potential equalization PA, the negative high-voltage potential HV_N is now reduced by the amount of the voltage of the DC charging station 6 below the potential equalization PA (−400 V).

From t=0.7 s, a second insulation fault is now assumed in the DC charging station 6 from the negative high-voltage potential HV_N to the potential equalization PA. This insulation fault is also assumed to be an ideal short circuit with 0 Ohm. This results in a potential distribution of 0 V from HV_P to the potential equalization PA and at the same time 0 Ohm from HV_N to the potential equalization PA on the side of the DC charging station 6. However, this should only be regarded as a theoretical distribution, since it can be assumed that although an insulation fault has a low resistance, it will never reach 0 Ohm.

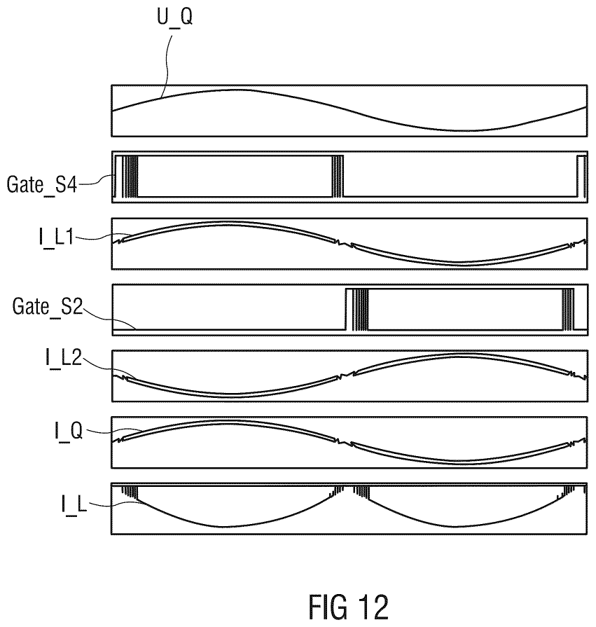

FIG. 12 is a schematic diagram with signals from a simulation of the inverter 1 (depicted in FIG. 1) with the circuit, wherein the AC charging function has been depicted at an AC charging station 7 (depicted in FIG. 1). The instantaneous value of the AC voltage U_Q fed in by the AC charging station 7 is ascertained via a voltage measurement. Depending on the sign, the correct semiconductor switch S2, S4 is then controlled such that the correct current is set for each half-wave. For example, the target current is 16 A, which should be set at the peak value of the voltage half-wave.

In the diagram, the source voltage U_Q of the AC charging station 7, the control signals Gate_S2, Gate_S4 of the semiconductor switches S2, S4 (depicted in FIG. 1), the current I_L1 in the stator winding L1 (depicted in FIG. 1), the current I_L2 in the stator winding L2 (depicted in FIG. 1), the current I_Q flowing from the AC charging station 7 and the charging current I_L of the high-voltage battery 3 (depicted in FIG. 1) are depicted. The object of the PFC function of the inverter 1 is to set a current for the two half-waves that is proportional to the voltage curve and whose peak value is 16 A. Setting the target current is carried out via a comparison with a proportionally reduced value of the voltage measurement. Here, a tolerance of +/−1 A, for example, is predetermined as the maximum deviation from the target current, i.e. as soon as the current 1 A in the positive half-wave is below the target specification, the corresponding semiconductor switch S4 is switched on in order to increase the current I_L1, I_L2 through the stator windings L1, L2. If the current current value is 1 A above the target value, then the semiconductor switch S4 is opened again. In this case, the current I_L1, I_L2 freewheels through the stator windings L1, L2 via the high-voltage battery 3 such that it is charged.

In the negative half-wave, switching takes place with the opposite sign, i.e. as soon as the current is 1 A below the (negative) target current, the semiconductor switch S2 is opened. As soon as the current is 1 A above the target current, the semiconductor switch S2 is closed again.

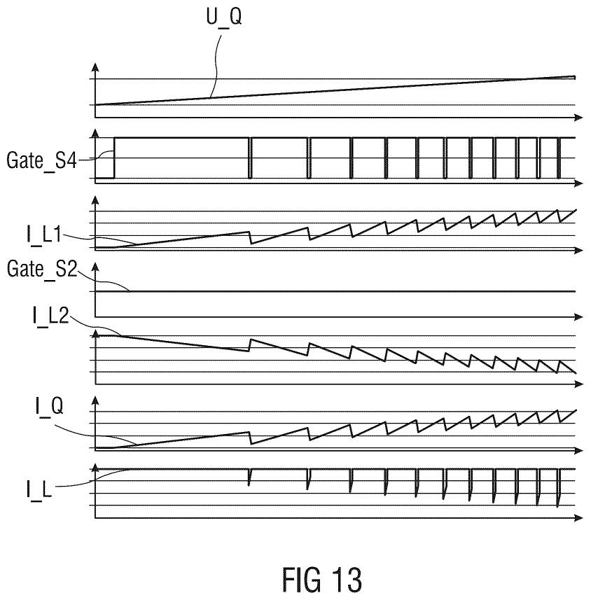

FIG. 13 is a schematic diagram with signals from the simulation of the inverter 1 (depicted in FIG. 1) with the wiring during AC charging at the beginning of the positive half-wave.

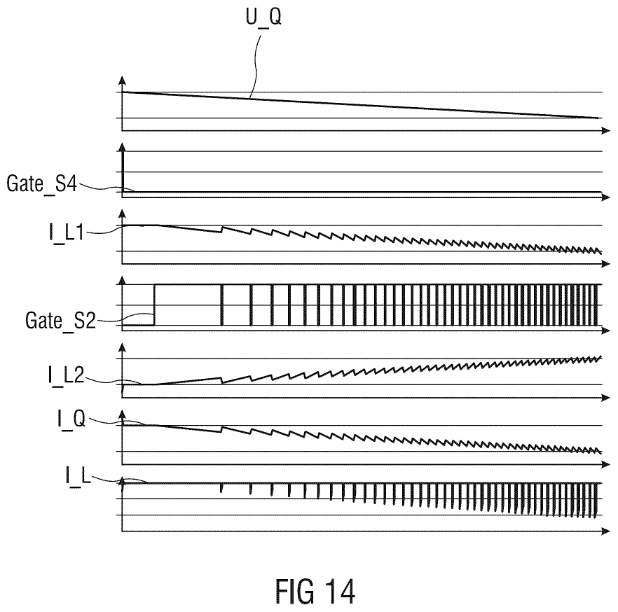

FIG. 14 is a schematic diagram with signals of the simulation of the inverter 1 (depicted in FIG. 1) with the wiring during AC charging at the beginning of the negative half-wave.

If the voltage between the negative high-voltage potential HV− (depicted in FIG. 1) and the potential equalization PA is taken into consideration in the simulation, it is noticeable that the negative high-voltage potential HV− is identical to the phase of the source voltage U_Q during the negative half-wave. In other words: in the negative half-wave, the HV potentials HV+, HV− (depicted in FIG. 1) of the vehicle are shifted in relation to the potential equalization PA=N=PE (protective conductor) according to a sine half-wave. This is also a typical behavior of a PFC. With large Y capacitances between HV+ or HV− and PA, this would lead to a leakage current that could trip a surge protector in a domestic installation (equalizing current flows to the protective conductor PE).

This can be remedied by:
1. small Y capacitances being arranged in the region of the PFC and then galvanically insulated via an insulating DC/DC converter 8, or
2. a compensating current being fed into the PE protective conductor.

Note on 1: For 800 V vehicles, the Y-capacities of the vehicle must be kept lower than for 400 V vehicles due to the C1 characteristic curve. Broken down to the Y-capacity of the inverter 1 (depicted in FIG. 1) including the electric engine 2 (depicted in FIG. 1), this means that:

For a 400 V inverter, a Y-capacitance of approximately 500 nF per high-voltage potential HV+, HV− should be provided.

For an 800 V inverter, a Y-capacitance of approximately 50 nF to 80 nF per high-voltage potential HV+, HV− should be provided.

It becomes clear that the leakage current is substantially lower in 800 V vehicles.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 Inverter
2 Electric engine
3 High-voltage battery
5 Charging socket
6 DC charging station
7 AC charging station
8 Insulating DC/DC converter
A Current measuring device
C Intermediate circuit capacitor, DC-link capacitor
D1, D2, D3, D4 coupling element, diode, semiconductor component, semiconductor switch
Gate_S2, Gate_S4 Control signal
HB1, HB2, HB3 Half-bridge
HV+, HV_N, HV−, HV_P High-voltage potential
I1, I2, I_HV+, I_HV−, I_Q, I_L1, I_L2 Current, freewheel current
I_L Charging current
L1, L2, L3 Stator winding
S1, S3, S5 High-side switch, semiconductor switch
S2, S4, S6 Low-side switch, semiconductor switch
S_Charge_1, S_Charge_2 Charging relay, charging contactor, relay contact
S_Main_P, S_Main_N Main contactor, main contactor contact
U_Q Source voltage

What is claimed is:

1. An electric drive system for a vehicle, the electric drive system comprising:
an electric engine configured to drive the vehicle and including three stator windings;
a high-voltage battery;
an inverter configured to convert a direct voltage of the high-voltage battery into an alternating voltage for supplying the electric engine, wherein the inverter has a B6 bridge made of three half-bridges, which are each of the three-half bridges are formed from two semiconductor switches, wherein center taps of each of the three half-bridges are respectively coupled to one of the three stator windings; and
a charging socket configured to charge for charging the high-voltage battery by a direct voltage or by single-phase charging of the high-voltage battery by an alternating voltage, wherein
a first diode or a first semiconductor switch with diode function is arranged with reverse polarity between the center tap of a first one of three half-bridges and a first contact of the charging socket,
a second diode or a second semiconductor switch with diode function is arranged with reverse polarity between the center tap of a second one of the three half-bridges and a second contact of the charging socket,
a third diode or a third semiconductor switch with diode function is arranged with forward polarity from a negative high-voltage potential of the inverter to the first contact of the charging socket,
a fourth diode or a fourth semiconductor switch with diode function is arranged with forward polarity from a negative high-voltage potential of the inverter to the second contact of the charging socket, and
an insulating DC/DC converter is switchable between DC terminals of the inverter and DC terminals of the high-voltage battery and is bridgeable by two main contactors.

2. The electric drive system of claim 1, wherein the two semiconductor switches or the first through fourth semiconductor switches with diode function are MOSFETs or IGBTs with a free-wheeling diode.

3. The electric drive system of claim 1, wherein the inverter comprises a DC-link capacitor.

4. The electric drive system of claim 1, wherein the inverter has current measuring devices, configured to measure alternating current, arranged between the center taps of each of the three half bridges and respective ones of the three stator windings.

5. The electric drive system of claim 1, further comprising:
two relay contacts arranged between a respective conductor and the first through fourth diodes or the first through fourth semiconductor switches with diode function connected thereto is isolate voltage of the first and second conductors of the charging socket.

6. A method for charging the high-voltage battery of the electric drive system at a DC charging station with boost function, the method comprising:
connecting the DC charging station to a charging socket of the electric drive system, wherein the electric drive system comprises
an electric engine configured to drive the vehicle and including three stator windings;
a high-voltage battery;
an inverter configured to convert a direct voltage of the high-voltage battery into an alternating voltage for supplying the electric engine, wherein the inverter has a B6 bridge made of three half-bridges, which are each of the three-half bridges are formed from two semiconductor switches, wherein center taps of each of the three half-bridges are respectively coupled to one of the three stator windings; and
a charging socket configured to charge for charging the high-voltage battery by a direct voltage or by single-phase charging of the high-voltage battery by an alternating voltage, wherein
a first diode or a first semiconductor switch with diode function is arranged with reverse polarity between the center tap of a first one of three half-bridges and a first contact of the charging socket,
a second diode or a second semiconductor switch with diode function is arranged with reverse polarity between the center tap of a second one of the three half-bridges and a second contact of the charging socket,
a third diode or a third semiconductor switch with diode function is arranged with forward polarity from a negative high-voltage potential of the inverter to the first contact of the charging socket,
a fourth diode or a fourth semiconductor switch with diode function is arranged with forward polarity from a negative high-voltage potential of the inverter to the second contact of the charging socket, and
an insulating DC/DC converter is switchable between DC terminals of the inverter and DC terminals of the high-voltage battery and is bridgeable by two main contactors;
controlling, in a clocked manner, a semiconductor switch arranged as a low-side switch of one of the three half-bridges, wherein the semiconductor switch is connected to the charging socket via one of the first and second diodes or one of the first through fourth semiconductor switches with diode function; and
operating the insulating DC/DC converter in a clocked manner to transfer power from a DC link capacitor of the inverter to the high-voltage battery or bridged by the two main contactors of the inverter.

7. A method for charging the high-voltage battery of the electric drive system at an AC charging station, the method comprising:
connecting the AC charging station to a charging socket of the electric drive system, wherein the electric drive system comprises
an electric engine configured to drive the vehicle and including three stator windings;
a high-voltage battery;
an inverter configured to convert a direct voltage of the high-voltage battery into an alternating voltage for supplying the electric engine, wherein the inverter has a B6 bridge made of three half-bridges, which are each of the three-half bridges are formed from two semiconductor switches, wherein center taps of each of the three half-bridges are respectively coupled to one of the three stator windings; and
a charging socket configured to charge for charging the high-voltage battery by a direct voltage or by single-phase charging of the high-voltage battery by an alternating voltage, wherein
a first diode or a first semiconductor switch with diode function is arranged with reverse polarity between the center tap of a first one of three half-bridges and a first contact of the charging socket,
a second diode or a second semiconductor switch with diode function is arranged with reverse polarity between the center tap of a second one of the three half-bridges and a second contact of the charging socket,
a third diode or a third semiconductor switch with diode function is arranged with forward polarity from a negative high-voltage potential of the inverter to the first contact of the charging socket,
a fourth diode or a fourth semiconductor switch with diode function is arranged with forward polarity from a negative high-voltage potential of the inverter to the second contact of the charging socket, and
an insulating DC/DC converter is switchable between DC terminals of the inverter and DC terminals of the high-voltage battery and is bridgeable by two main contactors;
controlling, in a clocked manner and during a positive half-wave of an alternating voltage fed in by the AC charging station, a semiconductor switch arranged as a low-side switch of one of the three half-bridges, wherein the semiconductor switch is connected to the charging socket via one of the first and second diodes or one of the first through fourth semiconductor switches with diode function; and
transferring power from a DC link capacitor of the inverter to the high-voltage battery via an insulating DC/DC converter of the electric drive system.
